(19) United States
(12) Patent Application Publication
(10) Pub. No.: US 2007/0129907 A1
(43) Pub. Date: Jun. 7, 2007

(54) Multifunction shoe with wireless communications capabilities

(76) Inventor: Ronald S. Demon, Lawrence, MA (US)

Correspondence Address: CAPITAL LEGAL GROUP, LLC, 5323 POOKS HILL ROAD, BETHESDA, MD, 20814, US

(21) Appl. No.: 11/293,370

(22) Filed: Dec. 5, 2005

(51) Int. Cl. G01D 1/00

(52) U.S. Cl. 702/127

(57) ABSTRACT

A multifunction shoe having wireless communications is provided. One embodiment includes a controller having a memory, a wireless transceiver in communication with the controller; a sensor system configured to measure shoe parameter data, and a support system for adjusting the support provided by the shoe. The controller may store and transmit user data, shoe parameter data, and performance data via the wireless transceiver. In addition, the controller may store user data of other users and program code received via the wireless transceiver.

### FIELD OF THE INVENTION

The present invention generally relates to a shoe, and more particularly to a shoe having wireless communications capabilities and multiple functions.

### BACKGROUND OF THE INVENTION

It is well known that the repeated impact of a person's foot with a traveling surface (such as a floor, roadway, or treadmill) while walking or running can be painful and may eventually lead to fatigue and joint (ankle, knee or hip) wear and tear or even damage. As a result, those skilled in the design and manufacture of shoes have endeavored to reduce the impact of the user's foot with the traveling surface by providing additional cushioning in the sole of the shoe. This is especially true in the design and manufacture of running and other athletic shoes.

A number of popular athletic shoes that have been available incorporate a sole that has an air pocket. However, the air pocket is enclosed so that the quantity of air in the pocket is constant so that the resistance to compression of the sole at the location of the air pocket is not variable. The air pocket simply provides a different resistance to compression than other portions of the rubber sole and is strategically placed in the sole to provide a more comfortable shoe.

In addition, pedometers for measuring the distance a user walks or runs are available in a variety of forms. However, it may be desirable to monitor and record the type and amount of movement of a shoe, such as for example, its acceleration, tilt, shoe contact time, and/or the pressure caused by impact of the shoe with the traveling surface. This information may be used in any of numerous manners by the user, by a physician, and/or others. Additionally, it may be desirable to store such data in a shoe and to communicate this data for external processing. Additionally, it may be desirable to transmit software, user data (such as user personal contact information), use data, and/or other data to or from the shoe.

In some instances the user may change his or her pace, acceleration, type of movement (e.g., lateral movement versus vertical movement versus forward movement), or other aspect of use. For example, a person engaged in playing basketball typically will engage in different types of movement than a person who is jogging. Also, a person engaged in vigorous physical activity may need maximum shoe support and when the person is not engaged in such activity may require only minimal support. Consequently, it may be desirable to automatically modify the amount or type of support or cushioning provided by the shoe based on the type of movement, the amount of activity, and/or other factors.

Another feature of interest is the ability to have a shoe exchange personal contact information with another shoe via a wireless medium. Such a feature may allow a user to exchange information with another user without the need to exchange a business card, to write down or otherwise record the information, or to make physical contact with the other user. Additionally, another feature that may be desirable is for the shoe to wirelessly receive or exchange information to identify other users with similar personal characteristics.

These and other features may be provided by one or more embodiments of the present invention.

### SUMMARY OF THE INVENTION

The present invention is directed to multifunction support shoe having wireless communications. One embodiment may include a controller having a memory, a wireless transceiver in communication with the controller; a sensor system configured to obtain shoe parameter data, and a support system for adjusting the support provided by the shoe. The controller may store and transmit user data (Personal contact information), shoe parameter data, and performance data via the wireless transceiver. In addition, the controller may store user data (Personal contact information) of other users and program code received via the wireless transceiver.

### DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown.

FIG. 1 is a functional block diagram of the components of one example embodiment of a shoe according to the present invention.

FIG. 2 is plan view of a section of the sole of one example embodiment of a shoe according to the present invention.

FIG. 3 is a schematic representation of communications of one example embodiment of a shoe according to the present invention.

### DETAILED DESCRIPTION

In the following description, for purposes of explanation and not limitation, specific details are set forth, such as particular networks, communication systems, computers, terminals, devices, components, techniques, data and network protocols, software products and systems, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, wireless transceivers, computers, terminals, devices, components, techniques, data and network protocols, software products and systems, operating systems, development interfaces, and hardware are omitted so as not to obscure the description of the present invention.

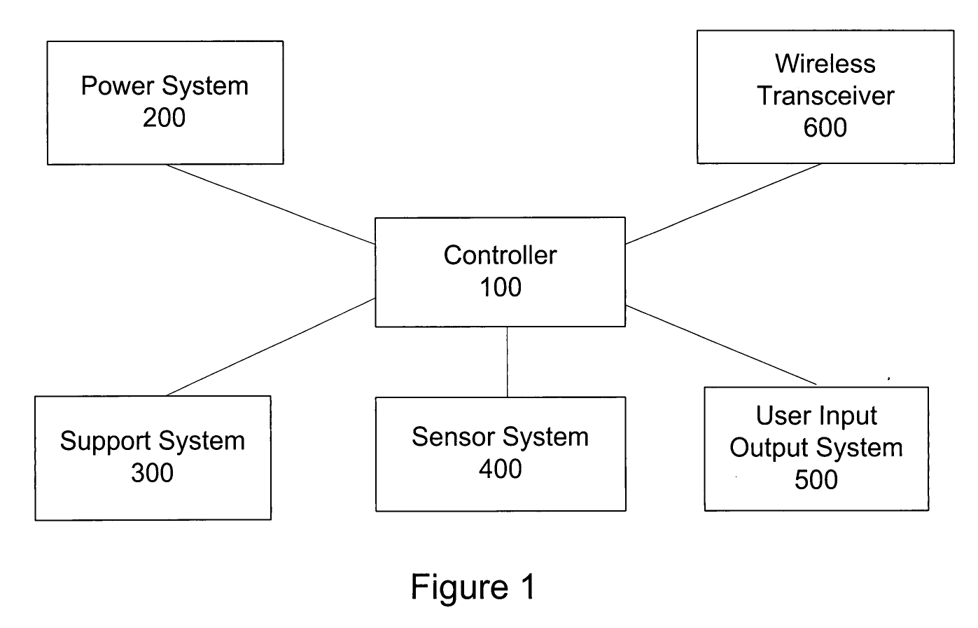

FIG. 1 illustrates the functional components that may be present in one example embodiment of a shoe 10 of the present invention. As illustrated, this embodiment may include a controller 100, a power system 200, a support system 300, a sensor system 400, a user input output (IO) system 500, and a wireless transceiver 600. Other embodiments may include additional or fewer components. As shown, controller 100 may be communicatively coupled to the other functional components, control the operation of the shoe 10, and also may receive data from and provide data to the various components. Support system 300 may include bladders that may be vary the support provided by the shoe 10. The sensor system 400 may include various sensors to measure various parameters related to the motion and use of the shoe. Such data may be provided to the controller 100, which may store the data, wireless transmit the data, process the data, and/or adjust the support provided by the support system 300. The power system 200 provides power to those functional components requiring power. Wireless transceiver 600 provides a means for controller 100 to communicate with external devices such as mobile telephones, personal digital assistants (PDAs), computers, and others.

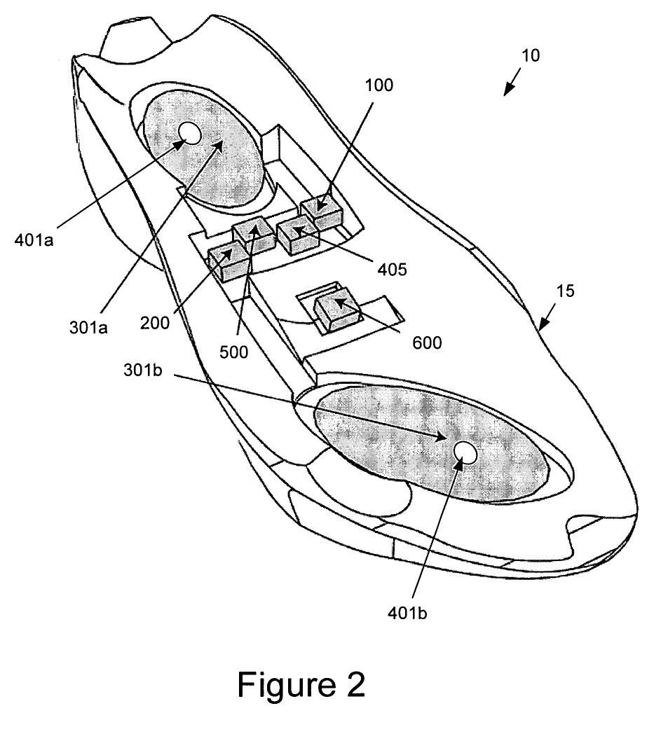

FIG. 2 depicts an embodiment in which the components of FIG. 1 are embedded in the sole of the shoe 10. In other embodiments, one or more of these components may be attached to, embedded in, or otherwise located in the shoe upper.

Power system 200 may include a battery power source in which one or more batteries are periodically removed and replaced or recharged and re-inserted. Alternately, power system 200 may include rechargeable power source in which a direct current (DC) energy source is periodically plugged into a receptacle of the shoe 10 similar to that of a mobile telephone. In another embodiment, the power system 200 may include a kinetic energy source which generates power through the movement of the shoe. Any suitable power source may be employed.

Support system 300 may include an electromechanical support mechanism configured to vary the support (herein to include cushioning) provided by the shoe in one or more areas. In one embodiment shown in FIG. 2, the support system may include a first bladder 301a disposed in the heel of the sole 15 of the shoe 10 and a second bladder 301b disposed in the front of the sole 15 of the shoe. In an alternate embodiment, the sole 15 of the shoe 10 may be divided into five zones, which roughly correspond to various weight bearing portions of the user's foot such as the heel, the toe, the shank, the ball, and the instep of the foot. Each zone may include a fluid bladder that is configured to provide support in its respective portion of the shoe 10. The support system 300 may reduce the impact experienced by the user's foot by regulating the escape of a fluid from the fluid bladders in each zone of the sole. The amount of support (including cushioning) provided by each bladder may be controlled by the controller 100, which may provide control data to valves (not shown) associated with each bladder 301 to control the flow of fluid in and/or out of the bladder. Thus, controller 100 may be in communication with fluid valves to vary the opening of the valves and thus control the flow of fluid entering or exiting the bladders.

In one embodiment, the fluid may be air and may be forced out of the bladders 301 due to pressure from the user's foot, which may deform the bladders 301. The air may be urged into the bladders 301 due to reformation of the bladders 301 to their original shape and size upon release of the pressure when the shoe leaves the traveling surface between stride impacts. In another embodiment, the fluid may be a liquid or other gas that is contained in a reservoir (not shown) that is housed in or on the shoe. Alternately, or in addition thereto, the valves may control the flow of fluid between the bladders. Additional bladders or other support mechanisms may be included in the upper portion of the shoe such as, for example, to provide support over the arch of the user's foot or around the ankle of the user's foot. An example of a support system is described in U.S. Pat. No. 5,813,142, which is hereby incorporated by reference in its entirety. While one embodiment may use bladders to provide support, other embodiments may employ other support mechanisms. For example, in another embodiment solenoids may be used to increase (tighten) or decrease (loosen) support around the user's ankle in response to control signals from the controller 100.

Sensor system 400 may include one or more sensors that measure one or more parameters associated with the shoe such as, for example, the relative change in pressure in each of the zones discussed above. The sensed data is typically provided to the controller 100 for processing, storage, and/or wireless transmission. For example, sensor system 400 may include one or more pressure sensors 401. Referring to FIG. 2, pressure sensors 401a and 401b of this example embodiment may be configured to measure the pressure in bladders 301a and 301b, respectively. This embodiment also may include a motion sensor 405 for measuring and/or sensing movement of the shoe 10. For example, motion sensor 405 may include an accelerometer that measures the acceleration of the shoe. In addition, or alternately, motion sensor 405 may include an impact detector that is configured to detect when the shoe impacts the traveling surface and/or one or more level sensors configured to measure the tilt of the user's shoe in one or two planes. In addition, data from pressure sensors 401 may be used by controller 100 to detect when the shoe impacts the traveling surface.

User input output system 500 may include various input and output means to allow the user to provide control inputs and to receive notifications. For example, user IO system 500 may include an input (e.g., a switch) to allow the user to turn off the shoe 10 (i.e., to power down the controller 100 and other functional components) and/or one or more outputs for providing alerts, notifications, or other information to the user. In various example embodiments, user IO system 500 may include visual output device such as a light emitting diode (LED), display (e.g., a liquid crystal display or LCD), or other such indicator. In addition, or alternately, user IO system 500 may include an audio output device such as a speaker to output an audible notification such as a pre-recorded audible voice output or buzzer. Alternately, a buzzer device may be used to output an audible buzzer notification. In addition, the user input output system may include a vibratory mechanism that is configured to produce a vibration in the shoe sufficient for alerting the wearer. Finally, user IO system 500 may include a knob or other manual input to be adjusted by the user to provide adjustments in support ranging from no additional cushioning to a maximum cushioning. This input may be used by the controller 100 to scale the amount of support.

Wireless transceiver 600 is communicatively coupled to controller 100 to facilitate wireless communications with other wireless capable devices. Wireless transceiver may be comprises of any suitable transceiver including, but not limited to, a transceiver compatible with an IEEE 802.1 a, b, or g (e.g., a Wifi transceiver) transceiver, a Bluetooth® transceiver, or a cordless telephone transceiver (e.g., 900 MHz, 2.4 GHz, or 5.8 GHz). Thus, the transceiver 600 may include, for example, a local area network (LAN) transceiver or a personal area network (PAN) transceiver. Alternately, the transceiver may be an infrared transceiver or a sonic transceiver.

Wireless transceiver 600 may be configured to facilitate communication with one or more other devices through any of the above listed or other communication protocols. Such devices may include, but are not limited to, a mobile telephone (e.g., a cellular telephone with Bluetooth, Wifi, or other wireless capabilities), a computer (e.g., a desktop, laptop or notebook computer with Bluetooth, Wifi, or other wireless capabilities), another shoe having a wireless transceiver 600 (e.g., a shoe worn by another person), a personal digital assistance (PCA), clothing having a wireless transceiver, and an automobile having a wireless transceiver.

Controller 100 may be comprised of a processor, memory (volatile and/or non-volatile), and a clock. In one example embodiment, controller 100 includes Flash memory for storing data and program code. The controller executes program code stored in its computer readable memory to control the operation of the shoe 10. The controller 100 may receive sensed data from sensory system 400, receive user data from user IO system 500, provide user output data to IO system 500, send control data to support system 300 to modify the support provided by the shoe 10, receive data from wireless transceiver 600, cause wireless transceiver 600 to transmit data, and perform other functions.

Controller 100 may receive sensed data such as pressure data, motion data, tilt data, and/or other data from sensor system 400. Some or all of such data may be stored in memory of controller 100. In addition, in response to receiving some data, controller 100 may cause support system to adjust the support or cushioning by controlling support system 300. For example, referring to FIG. 2 controller 100 may receive pressure data from sensors 401a and/or 401b and adjust the support provided by bladders 301a and/or 301b. In one embodiment, as the pressure increases over a threshold, controller 100 opens (perhaps only partially) a flow regulator to allow fluid to escape from a fluid bladder 301. The release of fluid from the fluid bladders may reduce the impact of the user's foot with the traveling surface to provide more cushioning. Similarly, controller 100 may receive motion data (e.g., acceleration data) from motion sensor 405 and process the data. Based on the processing of such data, controller 100 may vary the support provided by the shoe 10. For example, as discussed in more detail below, upon processing the data controller 100 may determine that the user is no longer engaged in a physical activity and reduce (loosen) ankle support or sole support. Similarly, controller 100 may be able to determine whether the user is active or inactive based on pressure data. For example, if the user is sitting, the pressure detected by pressure sensors 401 is likely to be less than if the user is standing and also more constant than if the user is walking or running. Further, controller 100 may be configured to detect (e.g., through pressure data) when the user has removed the shoes and, in response, power down the electronics of the shoe 10.

In one embodiment, controller 100 may include an analog-to-digital converter (ADC) for converting analog voltages from one or more sensors to digital data for storage, processing, and/or transmission. The ADC also may be used to sense the output (voltage and/or current) of the power system 200. Controller 100 may provide an alert to the user through user IO system 500 when the power system 200 output (voltage and/or current) falls below a predetermined threshold. In addition, controller 100 may include a digital-to-analog converter (ADC) for converting digital data from its processor to analog form for controlling support system 300 components.

Controller 100 also may be configured to process sensed data to determine the tilt of the shoe (e.g., whether the shoe is tilted in one or any direction above a predetermined angle such as forty-five degrees). In response to detecting tilt of the shoe for a predetermined time period (e.g., five seconds), the controller 100 may adjust the support. For example, in response to tilt in a first direction controller 100 may be configured to increase support and in response to a tilt in a second direction controller 100 may be configured to decrease support in one or more areas. Additionally, for purposes of communicating with another user device (e.g., a shoe 10, a computer, a mobile telephone), and as discussed in more detail elsewhere herein, the controller 100 may transmit or receive wireless signals via the wireless transceiver 600 in response to detecting the tilt of the shoe.

Through processing of data received over time from various sensors of sensor system 400, controller 100 may determine the user's speed (e.g., maximum or average), distance traveled, time of activity, foot contact durations, and other performance data. Controller 100 may transmit these and other performance data, along with the raw data which may be time-stamped, via wireless transceiver 600. Such data may be transmitted periodically, intermittently, upon receiving a request for transmission of data from an external device, upon receiving a user input via user IO system 500, upon detecting a predetermined user motion (e.g., a certain tilt of the shoe for a predetermined time period), and/or upon establishing wireless communications with an external device.

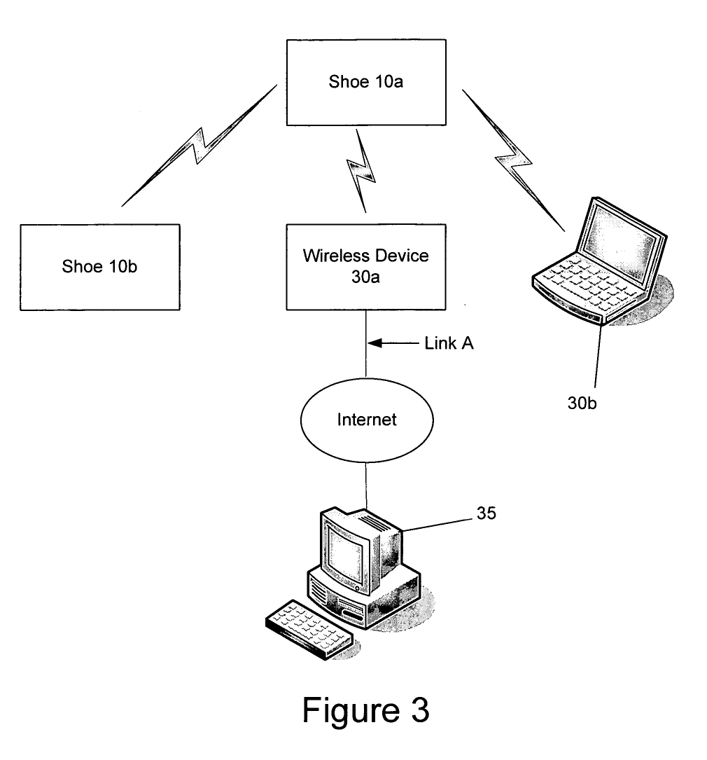

Referring to FIG. 3, in one example embodiment performance data is transmitted via wireless transceiver 600 in shoe 10 to a nearby wireless device 30a, which may be, for example a portable computer, PDA, mobile telephone, or other such device. One skilled in the art will recognize that wireless device 30a may be any device configured to communicate wirelessly including, but not limited to, those listed herein. Wireless device 30a may transmit the data over communication Link A and the internet to a remote computer 35. Link A may include wired and/or wireless segments. Computer 35 may process the performance data and/or raw measured data to provide information to the user (e.g., via the internet) and may also transmit data to shoe 10a. For example, computer 35 may transmit data, such as program code (which is meant to include data values for use by program code in the shoe 10a), to shoe 10a to allow controller 100 to provide improved support and/or performance to the user. Thus, computer 35 may transmit program code upgrades, patches, bug fixes, and other such software improvements to shoe 10. Controller 100 may receive and store the new program code in non-volatile memory, execute any new program code and/or use the new data during future operation. Additionally, the processing and functions described with respect for computer 35 may be performed by a local device such as wireless device 30a or 30b.

The controller 100 of shoe 10a may be configured to transmit and receive user data to/from other devices as well. For example, the user of the shoe 10a may transmit user data to the shoe from his or her computer 30a (e.g., wirelessly). Such data may be stored in memory of controller 100 and designated as public data (i.e., data to be shared) and other data may be designated as private. Subsequently, when the user is wearing the shoe 10a, he or she may come in sufficiently close proximity to another wireless device to permit wireless transceiver 600 to establish communications with the other wireless device. For example, referring to FIG. 3, due to movement of the user, shoe 10a may come sufficiently close to wireless device 30b (e.g., a notebook computer used by another person) or another person wearing a shoe 10b having wireless capabilities to allow shoe 10a to wirelessly exchange information with wireless device 30b or shoe 10b.

Any suitable negotiation, protocol, handshaking, or other process may be used to establish a communication between the devices including, for example, that used by Bluetooth compatible devices. Once the communication link between the devices is established, they may exchange all or select data (such as public data) stored in memory such as user data of each device. Such data, for example, may include user personal information (e.g., name, age, and sex), user personal contact information, (e.g., user's address, phone home phone number, mobile phone number, fax number, email address, business phone number, work address), business name (employer), employment title, academic or professional title (e.g., doctor, professor), user profile data (e.g., information of the user's interest, hobbies, affiliations, likes, dislikes, and other such information), binary or digital computer files (e.g., images and/or audio for the user), and other data supplied by the user or from another source. For example, shoe 10a may transmit user data to shoe 10b and shoe 10b may transmit user data to shoe 10a. Upon receipt of the user data from shoe 10b, controller 100 of shoe 10a may store the data for later transmission to a remote computer such as wireless device 30a or computer 35 (e.g., the user's home computer, mobile phone, or PDA) for review by the user. Thus, the shoe 10 provides a means for wirelessly exchanging user data and other data that is convenient and available when other means may not be available. While the described example embodiment is configured to exchange user data other embodiments may be used to exchange any data as desired by the user.

Controller 100 may include an operating system stored in memory as part of its program code. Other program code modules may execute as applications on the operating system to perform the functions described herein.

In one example embodiment, controller 100 may include the following applications Analysis/Response, Data Transfer, Record Motion, Debug, Intershoe Communications, Computer Communications, Learning. Execution of each of these applications may be controlled by the operating system and may correspond to a distinct mode of operation. Each mode may be independent from the others allowing multiple modes to operate at once. In one example embodiment, the operating system cycles through some of all of these modes.

In the Analysis/Response mode, controller 100 may analyze certain data and may provide a response. For example, controller 100 may determine that the user is (1) running if the peak pressure intervals sensed by pressure sensors are below a certain threshold time period; (2) walking if the peak pressure intervals sensed by pressure sensors are above a certain threshold time period; (3) standing if the sustained peak pressure sensed by pressure sensors is in a certain first range; (4) sitting if the sustained peak pressure sensed by pressure sensors is in a certain second range; (5) no longer wearing the shoe if the sustained peak pressure sensed by pressure sensors is in a certain third range. In response to one or more of these determinations, controller 100 may adjust the support provided by support system 300 or take other action (e.g., power down or go to sleep mode if the user has removed the shoe).

In one embodiment, after controller 100 has detected an activity, it may open, close, and/or adjust the valves once for the activity or the same amount each stride. In another embodiment, rather than open, close, or adjust the valve once, controller 100 may open, close, and/or adjust the valves several times and differently across a plurality of strides, which may can give the perception of the shoe being dynamically harder or softer. To do so, one example embodiment may store in memory a foot strike interval value (e.g., twenty strikes) and percentage of heel strikes. The percentage may correspond to the percentage of foot strikes per foot strike interval that will be given a soft (or lower) support versus a high (or harder) support, thereby corresponding to a shoe support adjustment ratio. Subsequently, when the controller detects an activity, the controller 100 may adjust the fluid bladders to provide the designated support in accordance with the support shoe adjustment ratio. Typically, the adjustments occur while the foot is in the air. In one example, the foot strike interval value is twenty strikes and the foot adjust ratio is 25% soft. This means that on every fourth heal strike (of each shoe), the valve is open (while shoe is in the air), and then closed on the fifth strike.

In one embodiment, controller 100 may be designed to run in a “power cycle mode” in which the controller 100 operates it, and one or more of its functional components, in the low power sleep mode for the majority of operation. Controller 100 may periodically awake, perform one or more function, and then return to sleep mode. Thus, the periodic use of sleep mode may reduce power usage.

In one example embodiment, controller 100 may be configured to receive and analyze user profile data received from another device (e.g., another shoe 10). If the received user profile data satisfies a similarity threshold with that of the profile data of the user, (which is stored in memory), controller 100 may alert the user by providing a visual, audible, or vibratory alert. For example, if the received profile data indicates that other person (corresponding to the received user profile data) has one or more of the same interests as the user of the shoe, controller 100 may cause user IO system 500 to produce an audible beep.

Finally, all of the data (e.g., thresholds, time periods and other data) described herein or that may otherwise be used by controller 100 to perform the functions described herein may be stored in memory by controller 100, during manufacturing, or via other means.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended

Those skilled in the art, having the benefit of the teachings of this specification, may affect numerous modifications thereto and changes may be made without departing from the scope and spirit of the invention.

What is claimed is:

1. A shoe to be worn by a user, comprising:
a controller having a memory;
a wireless transceiver in communication with said controller;
a sensor system configured to measure shoe parameter data; and
wherein said sensor system is in communication with said controller.

2. The shoe of claim 1, further comprising a support system configured to adjust the support provided by the shoe.

3. The shoe of claim 2, wherein said support system includes a fluid bladder.

4. The shoe of claim 3, wherein said support system further includes a flow regulator configured to adjust the flow of fluid exiting said fluid bladder.

5. The shoe of claim 3, wherein said sensor system includes a pressure sensor configured to measure the pressure in said fluid bladder.

6. The shoe of claim 5, wherein said controller is configured to automatically adjust the pressure in said bladder based on the sensing of a predetermined pressure in said bladder.

7. The shoe of claim 1, further comprising an output system configured to provide a notification to the user and wherein said output system is in communication with said controller.

8. The shoe of claim 1, wherein said controller is configured to cause said wireless transceiver to wirelessly transmit said shoe parameter data.

9. The shoe of claim 1, wherein
said memory includes user data stored therein; and
said controller is configured to cause said wireless transceiver to wirelessly transmit said user data in response to a trigger.

10. The shoe of claim 1, wherein said user data includes user contact information.

11. The shoe of claim 1, wherein said controller is configured to store first data received via said wireless transceiver in said memory.

12. The shoe of claim 11, wherein said first data comprises user data of the user.

13. The shoe of claim 11, wherein said first data comprises user data of a user of another wireless device.

14. The shoe of claim 11, wherein said first data comprises program code.

15. The shoe of claim 14, wherein said controller is configured to execute said program code.

16. The shoe of claim 1, wherein said controller is configured to process said sensed data to provide performance data.

17. The shoe of claim 16, wherein said controller is configured to wirelessly transmit said performance data.

18. The shoe of claim 1, wherein said wireless transceiver includes a Bluetooth® compatible transceiver.

19. The shoe of claim 1, wherein said wireless transceiver includes a IEEE 802.11 compatible transceiver.

20. The shoe of claim 1, wherein said wireless transceiver is configured to communicate with a mobile telephone.

21. The shoe of claim 1, further comprising a kinetic power source configured to supply power to said controller.

22. A method of using a shoe to be worn by a user, comprising:
measuring a shoe parameter to provide shoe parameter data;
storing the shoe parameter data in a memory;
wirelessly transmitting said shoe parameter data;
receiving first data via a wireless transmission; and
storing the first data in the memory.

23. The method of claim 22, further comprising adjusting the support member of the shoe in response to a shoe parameter measurement.

24. The method of claim 22, wherein the shoe parameter includes acceleration of the shoe.

25. The method of claim 22, wherein the shoe parameter includes the tilt of the shoe.

26. The method of claim 22, wherein the shoe parameter includes the pressure in a support area of the shoe.

27. The method of claim 22, further comprising storing user data of the user in the memory.

28. The method of claim 27, further comprising wirelessly transmitting the user data in response to a trigger.

29. The method of claim 28, wherein the trigger includes a request from remote transceiver.

30. The method of claim 27, wherein said user data includes user contact information.

31. The method of claim 22, further comprising:
wirelessly receiving user data of a user of another wireless device; and
storing the user data received via said wireless transceiver in the memory.

32. The method of claim 22, further comprising:
wirelessly receiving program code;
storing the program code in the memory; and
executing the program code.

33. The method of claim 22, further comprising processing the shoe parameter data to provide performance data.

34. The method of claim 33, further comprising wirelessly transmitting the performance data.

35. The method of claim 22, further comprising:
receiving the shoe parameter data at a remote device and wherein the shoe parameter data traverses a data path that includes the Internet.

36. A method of using a shoe to be worn by a user, comprising:
storing first user data of the user in a memory;
wirelessly transmitting the user data to a remote device;
wirelessly receiving second user data;
storing the second user data in the memory; and
wirelessly transmitting the second user data.

37. The method of claim 36, wherein the first user data and second user data each includes user contact data.
